(19) United States
(12) Patent Application Publication
(10) Pub. No.: US 2007/0116132 A1
(43) Pub. Date: May 24, 2007

(54) Method and system for control loop response time optimization

(75) Inventors: Nikolai Fediakine, Mountain View, CA (US); Shinkyo Kaku, San Jose, CA (US); Vitali Tikhonov, Mountain View, CA (US)

Correspondence Address: ARENT FOX PLLC, 1050 CONNECTICUT AVENUE, N.W., SUITE 400, WASHINGTON, DC, 20036, US

(73) Assignee: ALLIED TELEIS, INC.

(21) Appl. No.: 11/522,515

(22) Filed: Sep. 18, 2006

Related U.S. Application Data
(60) Provisional application No. 60/717,194, filed on Sep. 16, 2005.

(51) Int. Cl. H04B 14/04

(52) U.S. Cl. 375/242

(57) ABSTRACT

A method and system for optimizing a response time of a monitoring loop with forward error correction. Characteristics of a fiber optic communications channel are adjusted based on the number of errors corrected in the FEC decoder. An adaptive BER is calculated much faster by using a signal from an FEC decoder, than by comparing input and output transmission. Thereby, the lag time in adjusting the transmission characteristics of the fiber optic channel is minimized and the overall performance of the system is improved.

### CROSS-REFERENCE TO RELATED APPLICATIONS

This application is based upon and claims the benefit of priority from the prior U.S. Provisional Application No. 60/717,194 filed on Sep. 16, 2005, the entire contents of which is incorporated herein by reference.

This application is related to and incorporates in its entirety, nonprovisional U.S. Patent Application entitled “Apparatus and Method for Adaptive Adjustment and Performance Monitoring of Avalanche Photo-Diode Optical Receiver and Laser Transmitter for Fiber Link Long Haul Applications,” filed on Sep. 18, 2006.

### BACKGROUND OF THE INVENTION

1. Field of the Invention

This invention relates to methods and systems for control loop response time optimization. In particular, this invention relates to optimizing the response time of a control loop in a 10 Gigabyte-per-second (Gbps) Fiber Communication Channel with Forward Error Correction.

2. Background of the Technology

The advantages of network computing are increasingly evident, as the convenience and efficiency of providing information, communication, or computational power to individuals at their personal computers or other end user devices has led to rapid growth of such network computing, including Internet and intranet systems and applications.

Today's networks carry vast amounts of information. High bandwidth applications supported by these networks include streaming video, audio, and large aggregations of voice traffic. In the future, these bandwidth demands are certain to increase.

Recently, fiber optic communications has emerged as a viable means for transmitting data information over a network. The demand for quick reliable data transmission means continues to increase. Fiber optic communication channels provide means for reliable and efficient transmission of large volumes of data.

As bandwidth requirements increase, correcting errors in data transmission becomes increasingly important. Early methods of error correction, such as handshaking, required prior communication between the transmitting system and the receiving system. This method has many shortcomings, however, especially for systems which are transmitting information from one transmitter to multiple receivers at a time.

Another known method implements a monitoring loop which continuously calculates the Bit Error Rate (BER) and adjusts various system parameters in the attempt to decrease BER. One drawback to the use of a monitoring loop is that if the monitoring loop is based on the number of errors detected in the communication channel, then the response on an increase of the error rate cannot be faster than the measurement time, usually in the hundredths of seconds. For example, if a change occurs in one of the characteristics of the transmitter, the parameter cannot be adjusted faster than the measurement time. During the period while new measurements are taking place, the traffic across the media is subject to an increased BER for this extended period of time.

### SUMMARY OF THE INVENTION

There is a need in the art for methods and systems optimizing the response time of a monitoring loop, without the disadvantage of exposing network traffic to an increased BER for extended periods of time. The present invention solves these needs, as well as others, by providing a method and system for optimizing the response time of a control loop in communications channels with forward error correction. Specifically, in one embodiment of the present invention, the characteristics of a fiber optic communications channel which are adjusted based on the number of errors corrected in the FEC decoder. By determining the BER using the FEC decoder, rather than by comparing input transmission with output transmission, the system can determine the adaptive BER much faster. This reduces the lag time in making adjustments to the transmission characteristics of the fiber optic channel and improves the overall performance of the system.

Other objects, features, and advantages will be apparent to persons of ordinary skill in the art from the following detailed description of the invention and the accompanying drawings.

### BRIEF DESCRIPTION OF THE FIGURES

The above and other features and advantages of the present invention will become more apparent to those of ordinary skill in the art by describing in detail exemplary embodiments thereof with reference to the attached drawings in which:

FIG. 1 presents a computer system implementation capable of carrying out the functionality of one embodiment of the current invention.

FIG. 2 is a generalized scheme of a communication channel utilizing Forward Error Correction (FEC).

FIG. 3 is a high-level diagram of one embodiment of the performance monitoring system of the present invention.

FIG. 4 is a flowchart showing operation of one embodiment of the present invention.

FIG. 5 is a diagram of the architecture of an embodiment of the performance monitoring system of FIG. 3.

FIG. 6 is a graph showing receiver sensitivity and the relationship between the BER with and without FEC coding.

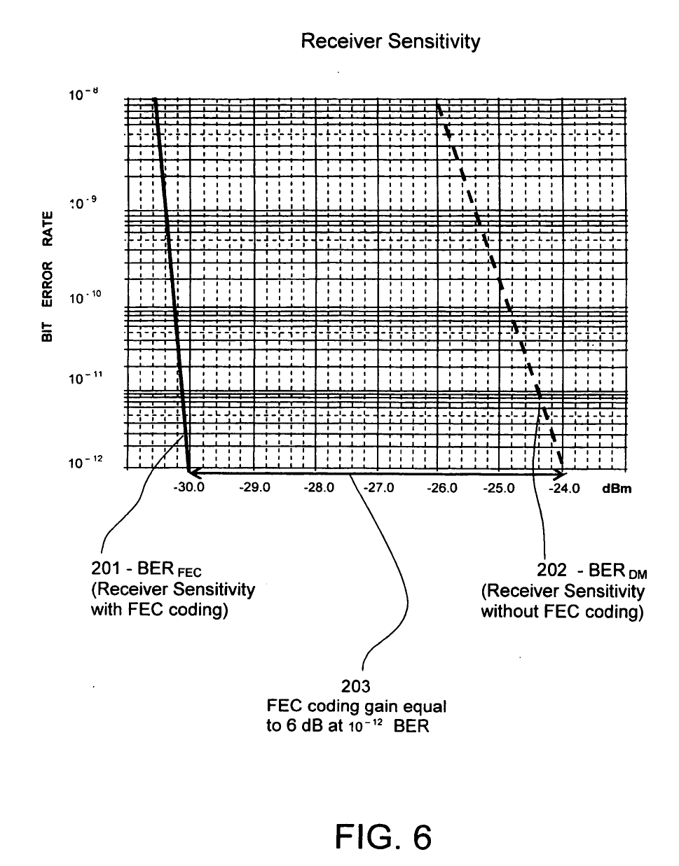

### DETAILED DESCRIPTION

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of elements may be exaggerated for clarity of illustration. Like reference characters refer to like elements throughout.

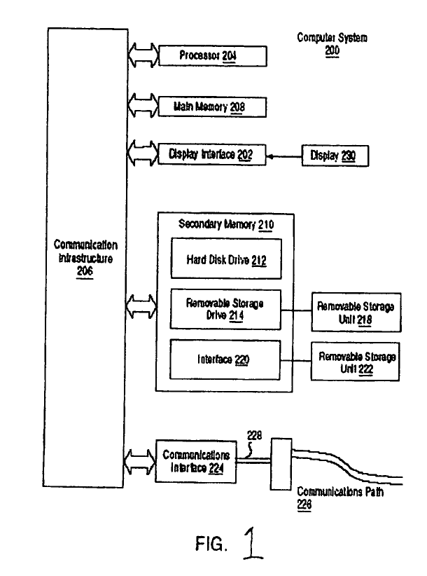

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 1.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

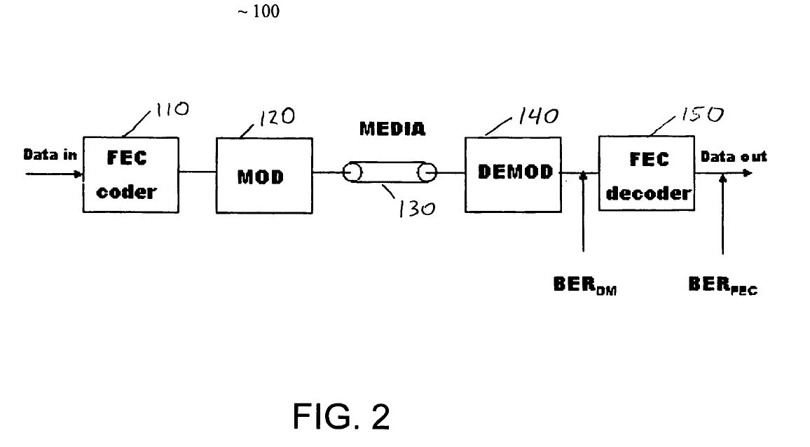

Under International Telecommunication Union Telecommunication Standardization Sector Standards G.709 (ITU-T G.709) and G.975 (ITU-T G.975), which are incorporated by reference herein in their entirety, certain fiber optic communication channels, for example, a 10GE/OC-192 fiber communication channel, as featured in one embodiment of the present invention, is equipped with FEC, and a system for monitoring the performance of the data transmission. FIG. 2 depicts a communications channel utilizing FEC. In FIG. 2, data is fed into FEC coder 110. The encoded data is then sent to a modulator 120, where the data is transmitted across a media 130, for example, a fiber optic cable. The signal is received at a demodulator 140, and the BER is calculated at the demodulator and is designated by BERDM. The demodulated signal is then sent to the FEC decoder 150, which completes the error correction and corrects the signal. The BER is then calculated at the FEC decoder and is designated by BERFEC. BERFEC is ideally multiple orders of magnitude smaller than BERDM. The error-corrected signal is then sent as the data output.

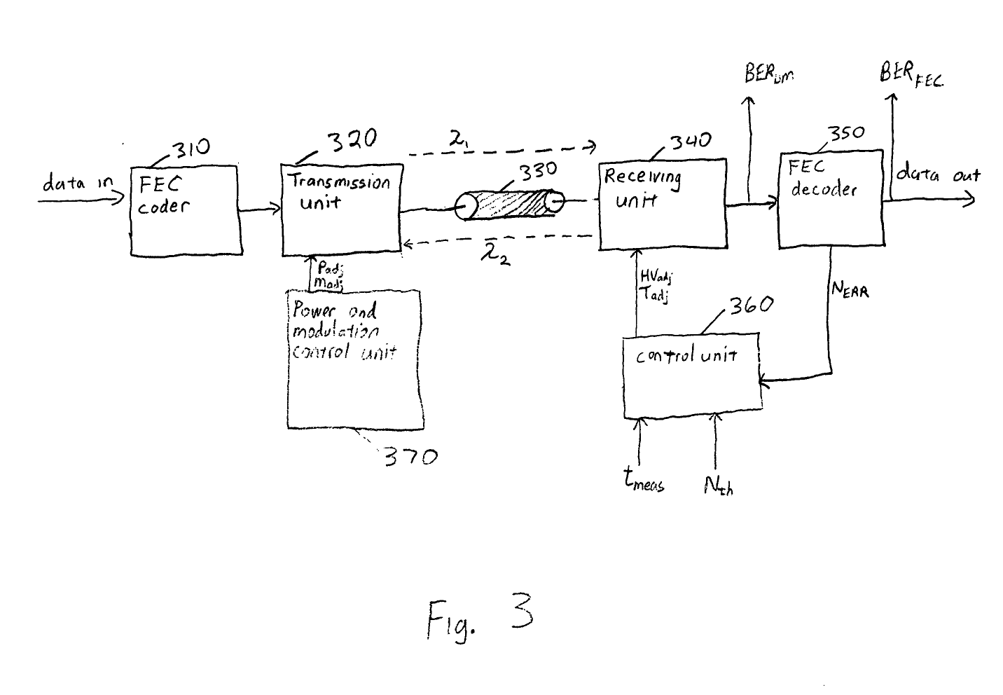

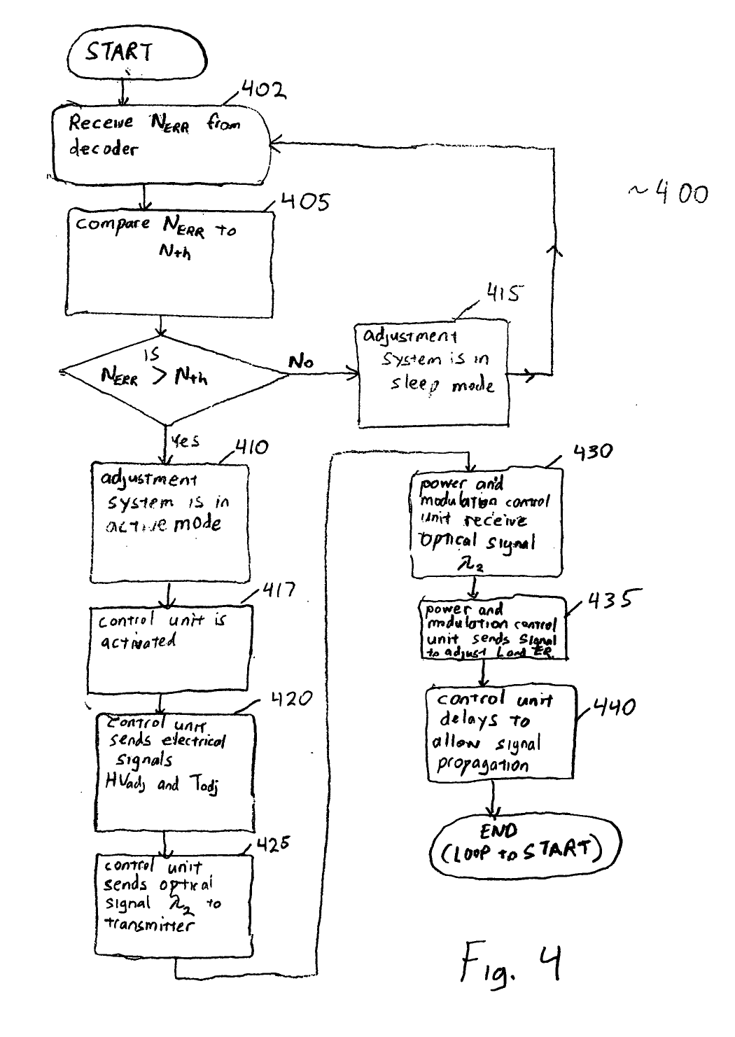

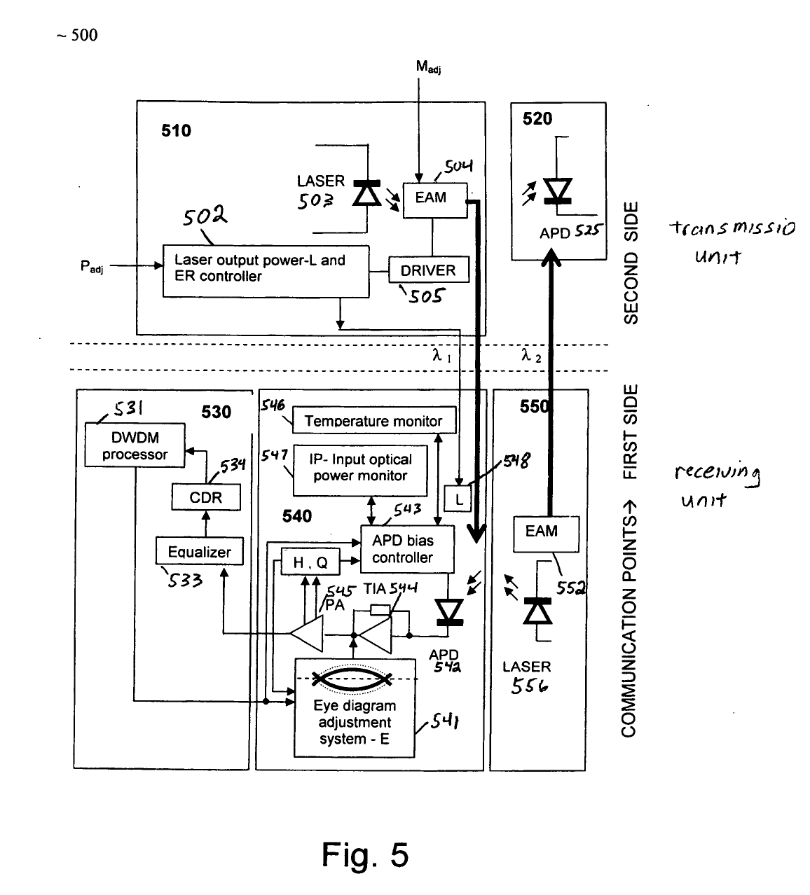

Referring now to FIG. 3, therein shown is a data transmission system 300 according to one embodiment of the present invention. FEC encoder 310 receives a data stream as input and outputs an encoded data stream. In one embodiment of the present invention, the FEC encoder is a Reed-Solomon encoder, for example, but any suitable FEC encoding device may be used. The encoded signal is then sent to transmission unit 320. Transmission unit 320, which is described in more detail in reference to FIG. 5, receives signals P_{adj} and M_{adj} from the power and modulation controller 370. Based on signals P_{adj} and M_{adj}, transmission unit 320 adjusts the optical signal λ₁, which is transmitted through a medium 330, such as a fiber or a cable. The optical signal λ₁ is received by the receiving unit 340, which is described in more detail in reference to FIG. 5. The received signal is then sent to the decoder, which decodes the signal using FEC. The decoder outputs the decoded and error-corrected data stream Data Out, and also outputs the number of errors corrected by the FEC decoder Nₑᵣᵣ to the control unit 360. In one embodiment of the method of the present invention, shown in FIG. 4, at step 420, the control unit 360 outputs two electrical signals, HV_{adj} and T_{adj}, which control the APD receiver. At step 425, control unit 360 outputs an optical signal λ₂, which is sent back across the medium 330 for controlling the power and modulation control unit 370. At step 435, power and modulation control unit 370 outputs two signals, P_{adj} and M_{adj}, which control the laser output power (L) and modulation amplitude of the laser.

What is claimed is:

1. A method for optimizing response time of a control loop, the method comprising:
receiving an encoded data stream at a receiving unit;
correcting errors in the encoded data stream; and
adjusting parameters of the receiving unit based on the number of errors corrected.

2. A method for optimizing response time of a control loop, the method comprising:
encoding a data stream with forward error correction;
transmitting the encoded data stream across a medium using a transmitting unit;
receiving the encoded data stream at a receiving unit;
decoding the data stream and performing error correction; and
adjusting parameters of the transmitting unit and the receiving unit based on the number of errors corrected when decoding the encoded data stream.

3. A system for optimizing response time of a control loop, the system comprising:
a transmitting unit;
a receiving unit;
a control unit for controlling the transmitting unit and the receiving unit; and
an error correcting unit for decoding a data stream and performing error correction;
wherein the control unit adjusts parameters of the transmitting unit and the receiving unit based on a number of errors corrected by the error correcting unit.
